(19) United States
(12) Patent Application Publication
(10) Pub. No.: US 2002/0101381 A1
(43) Pub. Date: Aug. 1, 2002

(54) Antenna arrangement

(76) Inventor: Hakan Segerstedt, Stocleholn (SE)

Correspondence Address: Samuels, Gauthier & Stevens LLP, Suite 3300, 225 Franklin Street, Boston, MA, 02110, US

(21) Appl. No.: 10/012,940

(22) Filed: Dec. 10, 2001

Related U.S. Application Data
(60) Provisional application No. 60/254,227, filed on Dec. 8, 2000.

(51) Int. Cl. H01Q 1/24

(52) U.S. Cl. 343/702; 343/846

(57) ABSTRACT

The present invention relates to an antenna arrangement (20, 30) comprising a radiator (21, 31), a ground structure (22, 32), a feet connector (23, 33) and ground connectors (24a, 24b; 34a, 34b). Said radiator comprises a first and a second end and that said radiator is connected to said ground sue at said first and second ends by means of said ground connectors (24a, 24b; 34a, 34b).

### TECHNICAL FIELD OF THE INVENTION

The present invention relates to an antenna arrangement comprising a radiator. a ground structure, feed connector and ground connector.

### BACKGROUND OF THE INVENTION

The size of the communication devices, such as radio transceivers, mobile telephones, Bluetooth equipped devices, etc., is reduced every day as a result of the reduced size of the electrical components. Moreover, the transmission rate of these devices has increased.

One critical point in a radio device is the antenna especially the size of the radiator. The antenna must be small, have high transmission rate and small.

IFAs (Inverted F-Antemas) 10 are known, as shown in FIG. 1, comprising a radiator 11 of [symbol] 4 type arranged in parallel with a ground plane 12 on a carrier, such as a printed circuit board. The radiator 11 is fed via a connector 13 and the radiator is connected to the ground via connector 14. The antenna has a minimum voltage at or close to the ground connection.

The IFA is usually a broadband antenna, and not suitable for small band applications. Moreover, the radiator is small in size, and e.g. in GHz applications, the antenna is mechanically instable, which means that the position of the radiator relative the ground connection. can be displaced, which affects the antenna characteristics.

Also, ILA (Inverted L Antenna) and patch antenna are known in which the radiator size and the distance between the radiator and ground plane is significant.

### SUMMARY OF THE INVENTION

Thus, the main object of the present invention is to provide an antenna arrangement of ground dependent type, which has a distinct distance between the radiator and the ground plane and has a minimum voltage at one end section of the radiator.

Other advantages with the antenna arrangement are the excellent electrical and RF characteristics and mechanical stability.

Therefore, in the initially described antenna arrangement the radiator comprises at least a first and a second end and that said radiator is connected to said ground structure at said first and second ends by means of said ground connectors.

### BRIEF DESCRIPTION OF THE DRAWINGS

In the following, the invention will be flier described in a non-lining way with reference to the accompanying drawing in which;

FIG. 1 is a schematic illustration of an IFA according to prior art,

FIG. 2 is a schematic illustration of an antenna according to the present invention,

FIG. 3 is a schematic perspective view of a second embodiment of the antenna according to the invention, and

FIG. 4a-4d are schematic views of further embodiments according to the invention.

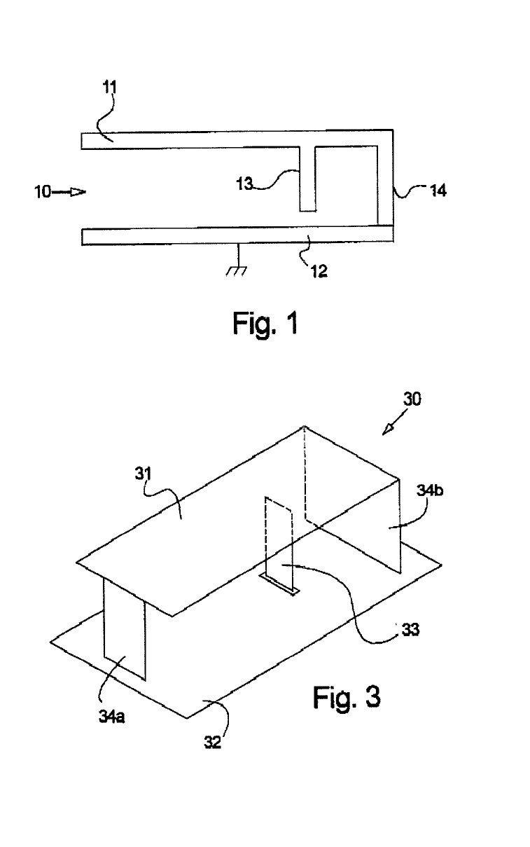

### DETAILED DESCRIPTION OF THE EMBODIMENTS

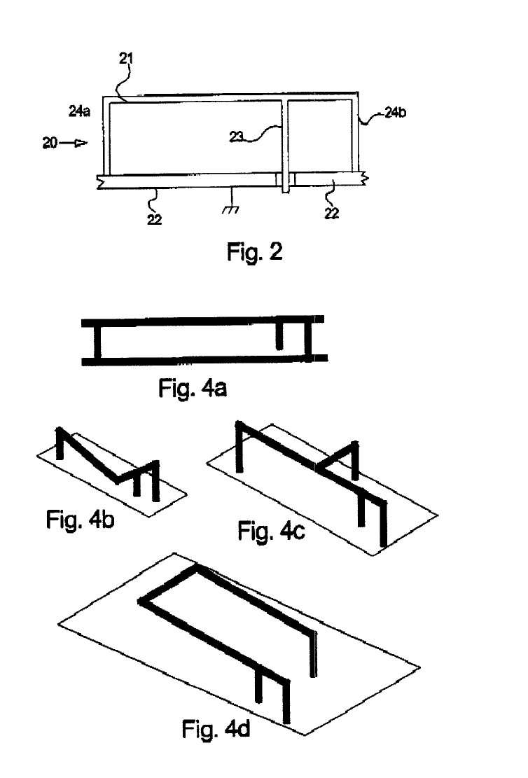

According to one preferred embodiment of the invention as shown in FIG. 2, the antenna 20 comprises an oblong radiator 21. a feed connector 23, ground connections 24a and 24b and a ground structure 22. The radiator 21 has a first and a second end and it is connected to the ground structure 22 by means of connectors 24a and 24b at said first and second end. Thus, a stable construction is obtained. The feed connector 23 is arranged so that a suitable impedance is achieved, e.g. 50 [symbol] . In this case the feed connector is arranged close to the ground connector 24b. The feed connector in this case extends through the ground structure via a hole and it is isolated from the ground. However, it can be arranged to contact the from above or a side.

Thus. the antenna obtained according to the invention is a [symbol] antenna which normally has better characteristics than a z,900 4 antenna, which can be a result of the amount of currents on the radiator.

The antenna element can consist of a wire or the like. It may also consist of a strip arranged on a carrier. As shown in FIG. 3, the antenna 30 may also consist of plate-shaped radiator 31 arranged above a ground plane 32. In this embodiment the ground connectors 34a and 34b have different dimensions. The radiator is fed via connector 33. This antenna corresponds to a Planar Inverted F-Antenna (PIEA).

The antenna according to the invention has different electrical properties than the prior art antennas described above. The diagram of FIG. 3 illustrates the with resect to the radiator's 21 extension. The minimum voltage is obtained at one grounded end where the feeding is arranged. The cross over from of the current direction is situated approximately at the middle section of the radiator.

The antenna may also comprise a non-conductive carrier on which the parts of the antenna are plated and which can be snapped above a ground plane.

Other embodiments of the antenna according to the invention are illustrated in FIGS. 4a-4c. In FIG. 4a, the ground connection are arranged m a distance from the ends of the radiator. In FIG. 4b, which is a perspective view, the radiator is substantially L-shaped. In FIG, 4c, the radiator is substantially T-shaped having a ground connection at the third end. 1a FIG. 4d, the radiator is substantially U-shaped.

The invention is not limited the shown embodiments but can be varied in a number of ways without departing from the scope of the appended claims and the arrangement and the method can be implemented in various ways depending on application, functional units, needs and requirements etc.

What we claim is:

1. Antenna arrangement comprising a radiator, a ground structure, a feed connector and ground connectors, wherein said radiator comprises at least one first and one second end, said radiator being connected to said ground structure at said first and second ends by means of said ground connectors.

2. The antenna arrangement of claim 1, wherein said radiator is arranged substantially parallel to said ground structure.

3. The antenna arrangement of clam 1, wherein said feed connector is arranged between said first and second ends such that a suitable impedance is obtained.

4. The antenna arrangement according claim 1 wherein said radiator consists of a wire.

5. The antenna arrangement according to clam 1, wherein said radiator is plate said.

6 The antenna arrangement according to claim 1, wherein said radiator is a strip arranged on a carrier.

7. The antenna arrangement according to claim 1, wherein said radiator, feed connected and ground connectors are arranged as a plated layer on a shaped non-conductive carrier.

8. The antenna arrangement according to claim 1, wherein said radiator is substantially L-shaped.

9. The antenna arrangement according to claim 1, wherein said radiator is substantially U-shaped

10. The antenna arrangement according to claim 1, where said radiator is substantially T-shaped.

11. The antenna arrangement according to claim 10, wherein said a ground connector is arranged at each end of said substantially T-shaped radiator.

12. The antenna arrangement according to claim 1, wherein said ground connectors are arranged in a distance from said first and second ends.

13. The antenna arrangement according to claim 1. wherein said arrangement is a [symbol] 2 antenna.

14. The antenna arrangement according to claim 2, wherein said impedance is 50 [symbol] .

15. A method of providing a [symbol] 2 antenna arrangement comprising a radiator, a ground structure, a feed connector and ground connectors, said radiator comprises at least first and second ends, the method comprising connecting said radiator to said ground structure at said first and second ends by means of said ground connectors and arranging said feed connector in a distance from one of said ground connectors such that a suitable impedance is obtained.
